(19) United States
(12) Patent Application Publication
(10) Pub. No.: US 2007/0239474 A1
(43) Pub. Date: Oct. 11, 2007

(54) Customer Service System and Method

(76) Inventor: Martin Stuart Christie, Northants (GB)

Correspondence Address: FAY SHARPE LLP, 1100 SUPERIOR AVENUE, SEVENTH FLOOR, CLEVELAND, OH, 44114, US

(21) Appl. No.: 11/587,196

(22) PCT Filed: Apr. 21, 2005
(86) PCT No.: PCT/GB05/01540

§ 371 Date: Mar. 28, 2007

(30) Foreign Application Priority Data
Apr. 22, 2004 (GB) 0408956.1

(51) Int. Cl. G06Q 30/00

(52) U.S. Cl. 705/1

(57) ABSTRACT

A customer service system for matching servers to customers according to service requests made by the customers, includes a user terminal (4) for entering service requests from the customers, a central controller (2) arranged to receive service requests from the user terminal (4), and a database (8) containing data relating to the servers, the data including the current availability of each server. A communications system (12,14,16) enables the central controller (2) to communicate with communication devices (16) carried by the servers. The central controller (2) is constructed and arranged to select a server to respond to each service request according to predetermined criteria, including the availability of the servers, and transmits a call signal via the communications system (12,14,16) to the selected server, so that the server can respond to the customer's service request.

The present invention relates to a customer service system and a method of matching servers to customers according to service requests made by the customers. In particular, but not exclusively, the invention relates to a method and system for use in shops, banks and similar establishments, where the customer requires assistance from a server (for example a shop assistant or bank official).

It is quite common in large retail establishments, for example electrical goods retailers and furniture stores, for the shop floor to be staffed by sales assistants, who roam the shop seeking out customers who require assistance. Sometimes, the customers will actively seek assistance, whereas on other occasions the shop assistants may offer assistance to the customers. Sometimes, particularly when the shop is busy, it can be frustrating for a customer if they are unable to locate an available shop assistant with the relevant knowledge and experience. On the other hand, if the customer is merely browsing, it can be off-putting if a shop assistant offers unsolicited assistance. This can make the shopping experience less than ideal for the customer and may result in the loss of potential sales. It can also result in inefficient use of the shop staff.

Particular problems may arise when the store stocks a very large range of goods and each shop assistant only has the knowledge and experience to provide assistance in relation to a limited range of those goods. For example, a large electrical retail store may stock domestic appliances (cookers, washing machines, refrigerators etc.), home entertainment equipment (television, audio equipment etc.), photographic equipment (cameras, camcorders), mobile telephones and computer equipment. Each member of the sales staff may have detailed knowledge of only one of these product groups.

Similar problems arise in other establishments such as banks, where customers may have to wait a considerable amount of time to see staff who are qualified to provide the requested service or advice. On the other hand, it is inefficient for simple matters to be dealt with by highly qualified members of staff, which could be handled equally well by less highly qualified personnel.

It is an object of the present invention to provide a customer assistance system that mitigates at least some of the aforesaid problems. In particular, but not exclusively, it is an object of the invention to provide a customer assistance system that allows efficient use of staff, by matching servers to customers, according to the nature of assistance that is required.

According to one aspect of the present invention there is provided a customer service system for matching servers to customers according to service requests made by the customers, the system including a user terminal for entering service requests from the customers, a central controller arranged to receive service requests from the user terminal, a database containing data relating to the servers, said data including the current availability of each server, and a communications system enabling the central controller to communicate with communication devices carried by the servers, wherein the central controller is constructed and arranged to select a server to respond to each service request according to predetermined criteria, said criteria including the availability of the servers, and to transmit a call signal via the communications system to the selected server, so that the server can respond to the customer's service request.

The system enables servers to respond efficiently to customers' service requests, ensuring that customers are served as quickly as possible, but are not bothered when service is not required. The system also ensures that the servers' time is used efficiently in dealing with service requests and is not wasted searching for customers who require assistance. This improves the customer service experience and ensures maximum usage of available customer service staff.

Advantageously, the database contains data relating to each server's competence in responding to requests for different types of service, the user terminal includes means for specifying the type of service that is requested, and the predetermined criteria include the servers' competence in responding to the specified type of service. This ensures that servers are matched to customers according to their needs. Therefore, if the customer requires technical advice in relation to a particular product, the system ensures that responding server has the necessary product knowledge. Alternatively, if the customer does not require technical advice, a server with a lower level of knowledge may be able to respond adequately to the service request. This ensures maximum efficiency in the deployment of staff personnel.

Preferably, the database contains data relating to each server's level of knowledge in relation to different products, the specified type of service includes information specifying a particular product, and the predetermined criteria include the servers' level of knowledge in relation to the specified product. The term “product” as used herein is intended to encompass both goods and services.

The system may include a server logging unit that is constructed and arranged to enable servers to log in and out of the system, for example when arriving at work or leaving. During the logging process, the identification code of the communication device taken by the server may be noted and recorded, allowing communication between the central controller and the server.

Advantageously, the communications system is constructed and arranged to enable two-way communication between the central controller and the servers. The communication devices carried by the servers are preferably constructed and arranged to enable the servers to indicate their availability or non-availability, for example when responding to a service request from another customer. The communications system may consist of a conventional two-way paging system, with pagers carried by the servers.

The user terminal may include display means for displaying information regarding selected products. These products may be selected automatically according to the nature of the service request entered by the customer, so that marketing information of interest to that customer is displayed. The user terminal may also include control means for selecting the displayed information, allowing the customer to choose what type of information is displayed. This may include, for example, technical information about the products in which the customer is interested.

The system may include a plurality of user terminals, each user terminal being associated with a particular product or group of products. For example, in a retail store, one user terminal may be associated with each product displayed within the store, allowing the customer to access information relating to that product, or enter a service request if further information or advice is required in relation to that product.

Advantageously, the central controller is constructed and arranged to calculate an estimated waiting time in relation to each service request, on the basis of predetermined criteria including the availability of servers. The user terminal preferably includes means for communicating the estimated waiting time to a customer. This reduces frustration on the part of the customer and allows them to decide whether to wait for service or return at another time.

The central controller may include a booking system for booking an appointment with a server in relation to a specific service request, so reducing the risk of lost custom, if the customer cannot be seen immediately.

According to another aspect of the invention there is provided a method of matching servers to customers according to service requests made by the customers, the method including receiving a service request from a customer via a user terminal, interrogating a database containing data relating to the servers, said data including the current availability of each server, selecting a server to deal with each service request according to predetermined criteria, said criteria including the availability of the servers, and transmitting a call signal to the selected server via a communication system, so that the server can respond to the customer's service request.

Advantageously, database contains data relating to each server's competence in responding to requests for different types of service, and the method includes receiving a request for a specified type of service, and selecting a server to respond to each service request according to criteria that include the servers' competence in responding to the specified type of service.

Preferably, the database contains data relating to each server's level of knowledge in relation to different products, and the method includes receiving a service request including data specifying a particular product, and selecting a server to respond to the service request according to criteria that include the servers' level of knowledge in relation to the specified product.

Advantageously, the servers log in and out of the system.

The method may include two-way communication between the central controller and the servers. The servers preferably indicate their availability or non-availability via the communications system.

Information regarding selected products or services may be displayed on the user terminal. The displayed information may be selected by the user.

Optionally, a plurality of user terminals may be provided, each user terminal being associated with a particular product or group of products.

The method may include calculating an estimated waiting time in relation to each service request, on the basis of predetermined criteria including the availability of servers, and optionally displaying the estimated waiting time on the user terminal.

The method may include booking an appointment with a server in relation to specific service requests.

Various embodiments of the invention will now be described by way of example, with reference to the accompanying drawings, in which:

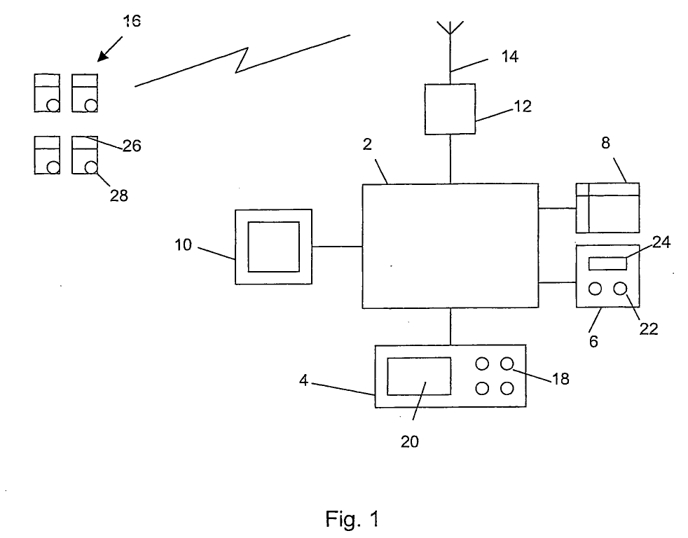

FIG. 1 is a schematic view of a first customer assistance system according to the present invention; and

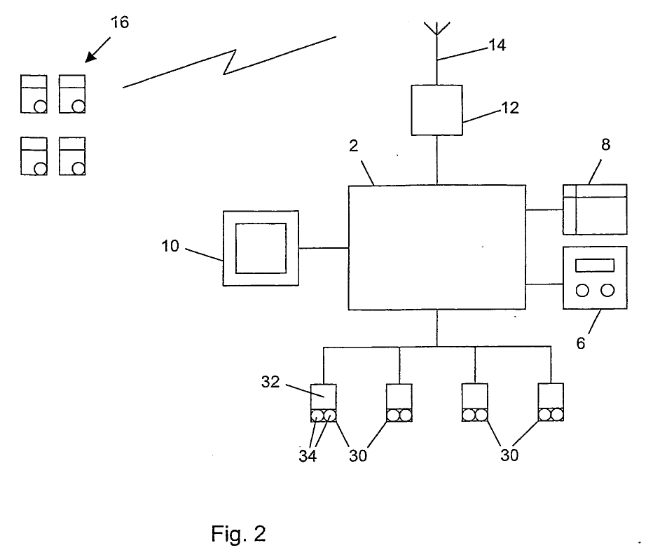

FIG. 2 is a schematic view of a second customer assistance system according to the present invention.

FIG. 1 shows a customer assistance system that is suitable, for example, for use in a bank. The system is designed to match the bank's customer service official to customer's service requests, according to the nature of those requests. These may range from simple matters such as queries about account entries or bank charges, to more complicated matters such as applications for a loan or mortgage.

The system includes a central controller 2, for example a computer, that is linked to various peripheral devices, including a user terminal 4, a server logging unit 6, a database 8, a customer display unit 10, and a wireless communications system 12 having an antenna 14. The communications system 12 allows the central controller 2 to communicate with a plurality of wireless communicators 16, for example paging units, which are carried by the bank's customer service officials (“the servers”).

The user terminal 4 includes a plurality of controls 18, which can be used either by a customer or, for example, by a receptionist, to submit details of the customer and the customer's service requirements to the central controller 2. The user terminal 4 may also have a screen 20 for displaying a variety of information including, for example, prompt questions for data required by the central controller, the data entered using the user terminal 4 and feedback from the central controller 2.

The server logging unit 6 includes controls 22 and optionally a display 24, and is intended to allow servers (i.e. bank employees) to enter their details when logging on or logging out of the system. When logging on to the system, the server will normally take one of the communicators 16, allowing two-way communication with the central controller. The data entered by the server when logging on will normally include the server's identity and a code that identifies their communicator 16. This information is recorded by the central controller 2 in the database 8. The database 8 also contains other predetermined information relating to the servers, including for example details of the server's qualifications, knowledge and experience in handling various customer service requests.

The communications system 12 allows two-way wireless communication between the central controller 2 and the communicators 16. The communications system may for example be a conventional 2-way paging system.

The customer display unit 10 is optional, but may be used to display information to the customer, for example while the customer is waiting for service. This information may include for example an indication of the server allocated to the customer, an estimate of the likely waiting time and other information that may be of interest to the customer, as may be determined from the customer's service request.

The communicators 16 may for example be conventional paging units. Each communicator 16 may include a display 26 and a controller 28, which allow the server to receive messages from the central controller 2 and respond to those messages.

By way of example only, use of the system shown in FIG. 1 in a bank will now be described.

Upon arriving for work, the servers (the bank officials) each collect a pager 16 and then log in using the logging unit 6. When logging in, each server identifies themselves and enters the identification code of the pager they have collected. This information is fed to the central controller 2 and stored in the database 8. The database 8 also contains additional information about each server, including for example their qualifications and levels of knowledge and experience, plus any other information that may be relevant in determining their suitability for handling specific customer enquiries (service requests).

When the server is ready to receive a customer, they send a signal to the central controller 2 from the pager 16, indicating that they are available. The central controller records this in the database 8.

When a customer makes a request for service, details of the service request (for example the type of information or advice required) is entered on the user terminal 4, together with details of the customer's identity. This information is submitted to the central controller 2. The information may be entered by a receptionist or possibly by the customer themself.

The central controller 2 checks the database 8 for servers who are logged in and have the appropriate level of knowledge and experience to handle the customer's service request, and selects the server who is best matched to the service request from those who are available. The central control unit 2 then transmits a call signal to the selected server via the communications system 12,14,16, which calls the server to meet the customer and deal with the service request. The call signal may optionally contain details of the customer's identity and the service request. The central control unit may also provide the customer with details of the server allocated to deal with the service request. This information may for example be displayed on a screen 10 or printed on a ticket given to the customer.

Upon receiving a call signal, the server sends an acknowledgement signal back to the central controller, to confirm that they will handle the service request. The central controller 2 then marks the database 8, to show that the server is now unavailable. Once the server has dealt with the customer's service request, he or she sends a signal back to the central controller, to indicate that they are again available.

If the central controller 2 finds that a suitably qualified server is not available immediately (for example because all suitable servers are already serving other customers or have pre-booked appointments), the central controller estimates the customer's waiting time according to the nature of the service requests with which the servers are engaged, the time already spent and the number of other customers already waiting. This estimated waiting time is communicated to the customer, either by the receptionist or via the screen 10, allowing the customer to decide whether to wait for a server to become available, or to make an appointment to meet a server at a future time and date. If the customer decides to wait, details of the service request are stored by the central controller and entered into a queuing system, and a call signal is sent to a suitably qualified server when one becomes available. If the customer decides to make an appointment, the details of the service request are entered into a diary system together with details of the server allocated to deal with that service request.

A customer service system for use in a retail store is shown in FIG. 2. The system is similar in some respects to the system shown in FIG. 1 and includes a central controller 2, a server logging unit 6, a database 8, a customer display unit 10 and a wireless communications system 12 having an antenna 14. The system also includes a plurality of wireless communicators 16, for example paging units, which are carried by the shop floor assistants (the “servers”). The system also includes a plurality of user terminals 30, which are linked to the central controller 2. Each server unit 30 includes a display screen 32 and a set of controls 34. The user terminals 30 are distributed around the store. For example, a separate user terminal may be associated with each product on display within the store. Alternatively, one or more user terminals may be located in each department of the store. Each user terminal has a unique identification code, which it sends to the central controller when communicating with the central controller, so that the central controller can identify the user terminal.

The user terminals are designed to be used by the customers. They are multi-functional devices, which can be used either to provide information about the products on display, or to call for assistance from a server.

In the information display mode, information relating to the products on display is shown on the display screen 32. Where a separate user terminal 4 is associated with each product on display within the store, the information will relate only to that product. Where the user terminals are not associated with specific products, for example where the terminals are located only in certain departments of the store, the product for which information is required can be selected using the controls 34. A wide variety of information may be displayed including, for example, product specifications and features, price and stock levels. The customer can select the information that is displayed by using the controls 34.

When a customer wishes to talk to a sales assistant about a product, the user terminal 30 can be used to call a server with a suitable level of knowledge. When the user places a server call, the user terminal sends a call signal to the central controller, together with an identification signal, which identifies the user terminal from which the request was made. Where the user terminal is not associated solely with a single product, the call signal may also include information identifying the product in which the user is interested, and the nature of the assistance required, as selected by the user. Where the customer unit is associated with only a single product, the central controller identifies that product from the database, which contains information identifying the product with which each customer unit is associated. The central controller uses this information to identify from the database 8 an available server who has an appropriate level of knowledge. Therefore, if the customer has requested further technical information about the product, the central controller will attempt to find a server with detailed knowledge of that product. On the other hand, if the customer has indicated through use of the user terminal that they do not require further information, but simply wish to make a purchase, the central controller may select a server with a lower level of product knowledge. As in the previous system, if the central controller is unable to find an available server with the appropriate level of knowledge, it may indicate to the customer via the display screen 32 an estimated waiting time. Details of the request will also be stored and transmitted to an appropriate server, when they become available. Alternatively, details of the service request may be transmitted to a supervisor, who can then delegate responsibility for dealing with the request to a chosen server.

The name of the server allocated to deal with the customer's request may also be displayed on the user terminal 4.

If the retail store does not require purchase requests to be channelled through a sales assistant, the user terminal may be used to order the product directly, so that it can be collected by the customer from a collection point. In that case, the customer may be provided with an order code, to confirm the order and allow collection of the goods.

As well as handling customer service requests, the central controller may also be used to monitor the performance of the servers. For example, it can be used to keep a record of the number of service requests handled by each server, the time spent dealing with each service request, the conversion rate of requests into purchases and so on. This information may be useful to the owners of the system, in monitoring the performance of the servers.

The system may also invite customers to indicate their level of satisfaction with the service they have received. This may be achieved for example, by positioning a customer display unit 10 at a checkout point, and asking the customer to rate the service they have received. This information may also be used to monitor the quality of service provided by the servers, as the server who dealt with the customer's service request can be identified from the record of transactions stored by the central controller.

The central controller may also include a “parking”0 facility, which allows a server to temporarily suspend service to one customer (for example, while awaiting delivery of stock), while dealing with an enquiry from another customer. The server can then revert later to the original customer, without losing details of their service request.

The system may also be useful in other retail stores, particularly where there is a need to manage customer's queuing and waiting times. For example, in a shoe shop, the system may be used to match customers to fitters according to the number and availability of fitters logged onto the system. By monitoring the number of customers waiting to be served and the availability of fitters, the system may be able to provide an estimated waiting time, allowing customers to leave the shop and return later, when a server allocated to them has become available.

1. A customer service system for matching servers to customers according to service requests made by the customers, the system including a user terminal for entering service requests from the customers, a central controller arranged to receive service requests from the user terminal, a database containing data relating to the servers, said data including the current availability of each server, and a communications system enabling the central controller to communicate with communication devices carried by the servers, wherein the central controller is constructed and arranged to select a server to respond to each service request according to predetermined criteria, said criteria including the availability of the servers, and to transmit a call signal via the communications system to the selected server, so that the server can respond to the customer's service request.

2. A customer service system according to claim 1, wherein the database contains data relating to each server's competence in responding to requests for different types of service, the user terminal includes means for specifying the type of service that is requested, and the predetermined criteria include the servers' competence in responding to the specified type of service.

3. A customer service system according to claim 2, wherein the database contains data relating to each server's level of knowledge in relation to different products, the specified type of service includes information specifying a particular product, and the predetermined criteria include the servers' level of knowledge in relation to the specified product.

4. A customer service system according to claim 3, including a server logging unit that is constructed and arranged to enable servers to log in and out of the system.

5. A customer service system according to claim 4, wherein the communications system is constructed and arranged to enable two-way communication between the central controller and the servers.

6. A customer service system according to claim 5, wherein the communication devices carried by the servers are constructed and arranged to enable the servers to indicate their availability or non-availability.

7. A customer service system according to claim 6, wherein the user terminal includes display means for displaying information regarding selected products.

8. A customer service system according to claim 7, wherein the user terminal includes control means for selecting the displayed information.

9. A customer service system according to claim 8, including a plurality of user terminals, each user terminal being associated with a particular product or group of products.

10. A customer service system according to claim 9, wherein the central controller is constructed and arranged to calculate an estimated waiting time in relation to each service request, on the basis of predetermined criteria including the availability of servers.

11. A customer service system according to claim 10, wherein the user terminal includes means for communicating the estimated waiting time to a customer.

12. A customer service system according to claim 11, in which the central controller includes a booking system for booking an appointment with a server in relation to a specific service request.

13. A method of matching servers to customers according to service requests made by the customers, the method including receiving a service request from a customer via a user terminal, interrogating a database containing data relating to the servers, said data including the current availability of each server, selecting a server to deal with each service request according to predetermined criteria, said criteria including the availability of the servers, and transmitting a call signal to the selected server via a communication system, so that the server can respond to the customer's service request.

14. A method according to claim 13, wherein the database contains data relating to each competence in responding to requests for different types of se method includes receiving a request for a specified type of services and selecting a server to respond to each service request according to criteria that include the servers' competence in responding to the specified type of service.

15. A method according to claim 14, wherein the database contains date relating to each server's level of knowledge in relation to different products, and the method includes receiving a service request including data specifying a particular product, and selecting a server to respond to the service request according to criteria that include the servers' level of knowledge in relation to the specified product.

16. A method according to claim 15, wherein the servers log in and out of the system.

17. A method according to claim 16, including two-way communication between the central controller and the servers.

18. A method according to claim 17, wherein the servers indicate their availability or non-availability via the communications system.

19. A method according to claim 18, wherein information regarding selected products or services is displayed on the user terminal.

20. A method according to claim 19, wherein the displayed information is selected by the user.

21. A method according to claim 20, wherein a plurality of user terminals are provided, each user terminal being associated with a particular product or group of products.

22. A method according to claim 21, including calculating an estimated waiting time in relation to each service request, on the basis of predetermined criteria including the availability of servers.

23. A method according to claim 22, including displaying the estimated waiting time on the user terminal.

24. A method according to claim 23, including booking an appointment with a server in relation to specific service requests.
